(19) United States
(12) Patent Application Publication
(10) Pub. No.: US 2026/0051435 A1
(43) Pub. Date: Feb. 19, 2026

(54) LAMINATED COIL COMPONENT

(71) Applicant: Murata Manufacturing Co., Ltd., Kyoto-fu (JP)

(72) Inventors: Yasushi TAKEDA, Nagaokakyo-shi (JP); Yuki ESAKI, Nagaokakyo-shi (JP)

(73) Assignee: Murata Manufacturing Co., Ltd., Kyoto-fu (JP)

(21) Appl. No.: 19/275,484

(22) Filed: Jul. 21, 2025

(30) Foreign Application Priority Data
Aug. 14, 2024 (JP) 2024-135391

(51) Int. Cl. H01F 27/28; H01F 27/24; H01F 27/29

(52) U.S. Cl. CPC H01F 27/2804; H01F 27/24; H01F 27/292; H01F 2027/2809

(57) ABSTRACT

A laminated coil component includes a laminated body including insulating layers laminated in a length direction and a coil, and first and second external electrodes each electrically connected to the coil. The coil includes coil conductors each laminated together with the insulating layer in the length direction and electrically connected to each other. A lamination direction of the laminated body and a coil axis direction of the coil are parallel to a first main surface which is a mounting surface of the laminated body. The laminated body satisfies B_W≤200 μm, B_L≤400 μm, and 200 μm≤B_T, or B_T≤200 μm, B_L≤400 μm, and 200 μm≤B_W where dimensions of the laminated body in the width, height and length directions are defined as B_W, B_T, and B_L, respectively, and an inner diameter area of the coil is 7500 μm² or more.

### CROSS-REFERENCE TO RELATED APPLICATION

This application claims benefit of priority to Japanese Patent Application No. 2024-135391, filed Aug. 14, 2024, the entire content of which is incorporated herein by reference.

### BACKGROUND

### Technical Field

The present disclosure relates to a laminated coil component.

### Background Art

As a laminated coil component, for example, Japanese Patent Application Laid-Open No. 2023-82190 discloses a laminated coil component of 0603 size.

### SUMMARY

In accordance with downsizing of electric devices in recent years, downsizing of laminated coil components has been required. However, for example, when the laminated coil component described in Japanese Patent Application Laid-Open No. 2023-82190 is simply downsized to have a 0402 size, there is a possibility that low frequency characteristics, specifically, the transmission coefficient S21 (S21 characteristics) in a low frequency band becomes insufficient.

Accordingly, the present disclosure provides a laminated coil component that can be downsized and has excellent low frequency characteristics.

A laminated coil component of the present disclosure includes a laminated body formed by laminating a plurality of insulating layers in a length direction and incorporating a coil therein, and a first external electrode and a second external electrode each electrically connected to the coil. The coil is formed by electrically connecting a plurality of coil conductors each laminated together with the insulating layer in the length direction to each other. The laminated body includes a first end surface and a second end surface facing each other in the length direction, a first main surface and a second main surface facing each other in a height direction orthogonal to the length direction, and a first side surface and a second side surface facing each other in a width direction orthogonal to the length direction and the height direction. Also, a lamination direction of the laminated body and a coil axis direction of the coil are parallel to the first main surface, the first main surface is a mounting surface, the laminated body satisfies B_W≤200 μm, B_L≤400 μm, and 200 μm≤B_T, or B_T≤200 μm, B_L≤400 μm, and 200 μm≤B_W where dimensions of the laminated body in the width direction, the height direction, and the length direction are B_W, B_T, and B_L, respectively, and an inner diameter area of the coil is 7500 μm² or more.

According to the present disclosure, it is possible to provide a laminated coil component that can be downsized and has excellent low frequency characteristics.

### BRIEF DESCRIPTION OF THE DRAWINGS

FIG. 1 is a schematic perspective view illustrating an example of a laminated coil component according to a first embodiment;

FIG. 2A is a side view of the laminated coil component illustrated in FIG. 1;

FIG. 2B is a front view of the laminated coil component illustrated in FIG. 1;

FIG. 2C is a bottom view of the laminated coil component illustrated in FIG. 1;

FIG. 3 is a sectional view schematically illustrating an example of the laminated coil component of the first embodiment;

FIG. 4 is an exploded perspective schematic view schematically illustrating a state of insulating layers constituting the laminated coil component illustrated in FIG. 3;

FIG. 5 is a schematic exploded plan view schematically illustrating a state of the insulating layers constituting the laminated coil component illustrated in FIG. 3;

FIG. 6 is a plan view schematically illustrating another example of a repetitive shape of a coil conductor constituting the laminated coil component illustrated in FIG. 3;

FIG. 7 is a plan view schematically illustrating another example of the repetitive shape of the coil conductor constituting the laminated coil component illustrated in FIG. 3;

FIG. 8 is a plan view schematically illustrating another example of the repetitive shape of the coil conductor constituting the laminated coil component illustrated in FIG. 3;

FIG. 9 is a plan view schematically illustrating the repetitive shape of the coil conductor constituting the laminated coil component illustrated in FIG. 3;

FIG. 10 is a schematic perspective view illustrating an example of a laminated coil component according to a second embodiment;

FIG. 11A is a side view of the laminated coil component illustrated in FIG. 10;

FIG. 11B is a front view of the laminated coil component illustrated in FIG. 10;

FIG. 11C is a bottom view of the laminated coil component illustrated in FIG. 10;

FIG. 12 is a sectional view schematically illustrating an example of the laminated coil component of the second embodiment;

FIG. 13 is a schematic exploded plan view schematically illustrating a state of insulating layers constituting the laminated coil component illustrated in FIG. 12;

FIG. 14 is a view schematically illustrating a method of measuring the transmission coefficient S21;

FIG. 15 is a graph showing the transmission coefficients S21 of Samples 1 to 4;

FIG. 16 is a graph showing the transmission coefficients S21 of Samples 4 to 7; and

FIG. 17 is a graph showing a relationship between the transmission coefficient S21 at 1 GHz and an inner diameter area of a coil in each sample.

### DETAILED DESCRIPTION

Hereinafter, a laminated coil component of the present disclosure will be described. However, the present disclosure is not limited to the following embodiment, and can be appropriately modified and applied without changing the gist of the present disclosure. It should be noted that those obtained by combining two or more of individual desirable configurations to be described below are also the present disclosure.

The drawings illustrated below are schematic views, and dimensions, scales of aspect ratios, and the like may be different from those of actual products. In the drawings, the same or corresponding parts are denoted by the same reference numerals. In each drawing, the same elements are denoted by the same reference numerals, and redundant description will be omitted.

In the present specification, the term (for example, “parallel”, “orthogonal”, and the like) indicating a relationship between elements and the term indicating a shape of an element not only mean only a strictly literal aspect, but also mean a range including a substantially equivalent range, for example, a difference of about several %.

The embodiments illustrated below are mere examples, and needless to say that the configurations can be partially replaced or combined in the different embodiments. In the second and subsequent embodiments, the description of matters that are common to the first embodiment will be omitted, and only the differences will be described. In particular, the same actions and effects achieved by the same configurations will not be sequentially described for each embodiment.

### First Embodiment

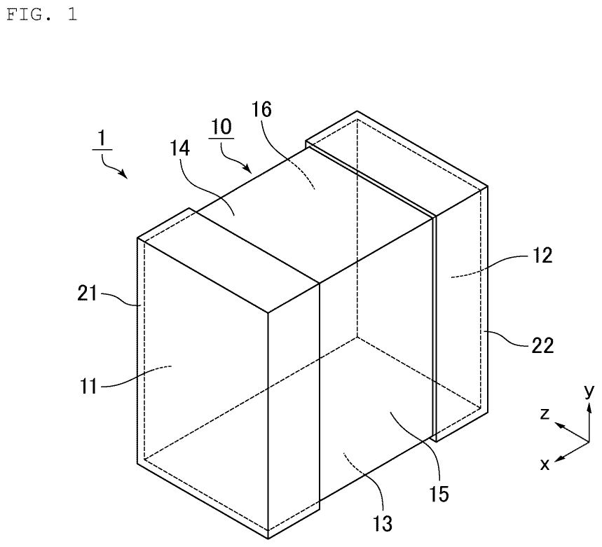

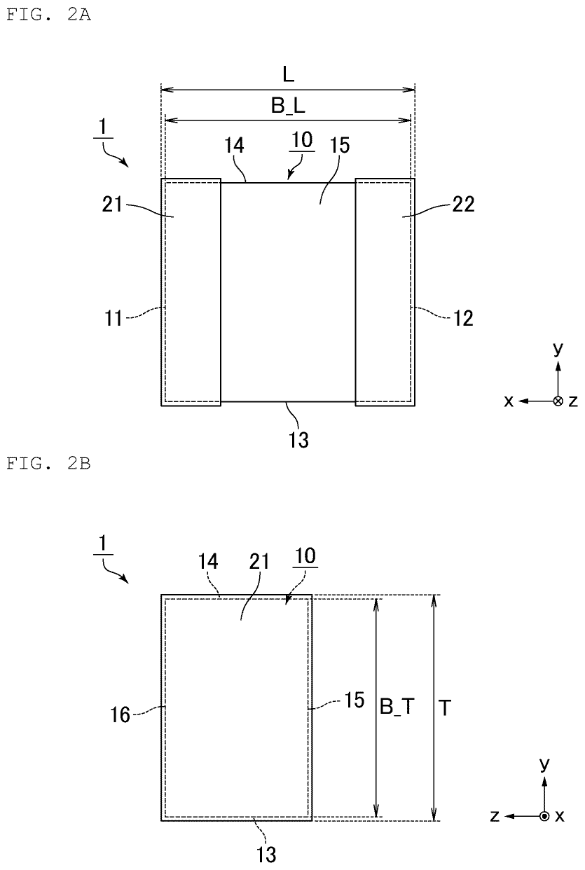

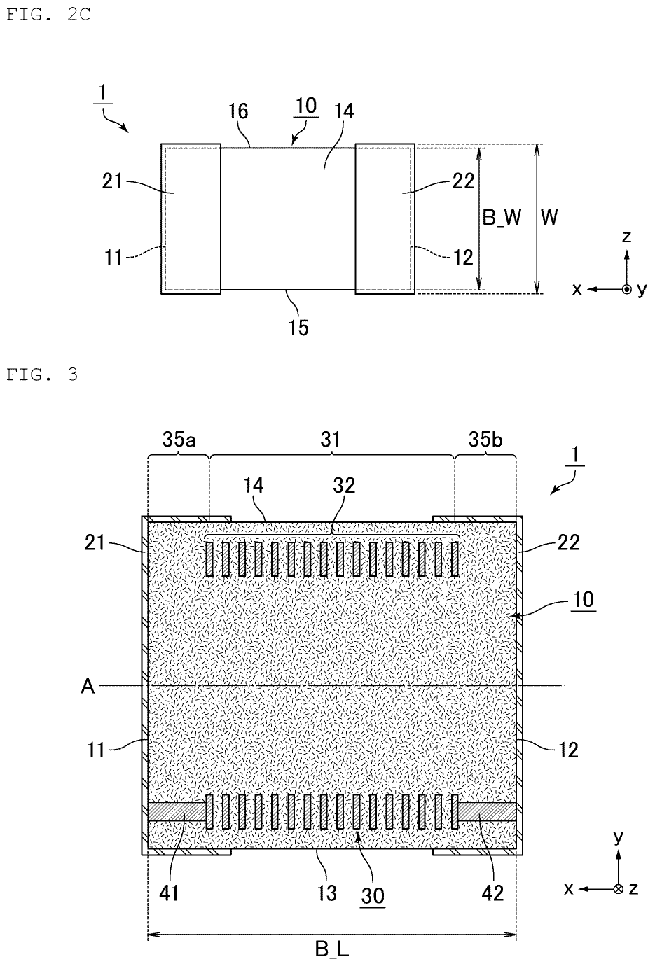

FIG. 1 is a schematic perspective view illustrating an example of a laminated coil component according to a first embodiment. FIG. 2A is a side view of the laminated coil component illustrated in FIG. 1, FIG. 2B is a front view of the laminated coil component illustrated in FIG. 1, and FIG. 2C is a bottom view of the laminated coil component illustrated in FIG. 1.

A laminated coil component 1 illustrated in FIGS. 1, 2A, 2B, and 2C includes a laminated body 10, a first external electrode 21, and a second external electrode 22. The laminated body 10 has a substantially rectangular parallelepiped shape having 6 surfaces. Although the configuration of the laminated body 10 will be described later, a plurality of insulating layers are laminated in the length direction, and a coil is incorporated in the laminated body 10. Each of the first external electrode 21 and the second external electrode 22 is electrically connected to the coil.

In the laminated coil component and the laminated body of the present disclosure, the length direction, the height direction, and the width direction are defined as an x direction, a y direction, and a z direction, respectively, in FIG. 1. Here, the length direction (x direction), the height direction (y direction), and the width direction (z direction) are orthogonal to each other.

As illustrated in FIGS. 1, 2A, 2B, and 2C, the laminated body 10 has a first end surface 11 and a second end surface 12 facing each other in the length direction (x direction), a first main surface 13 and a second main surface 14 facing each other in the height direction (y direction) orthogonal to the length direction, and a first side surface 15 and a second side surface 16 facing each other in the width direction (z direction) orthogonal to the length direction and the height direction.

Although not illustrated in FIG. 1, corners and ridges of the laminated body 10 are preferably rounded. The corner is a portion at which three surfaces of the laminated body intersect, and the ridge is a portion at which two surfaces of the laminated body intersect.

As illustrated in FIGS. 1, 2A, 2B, and 2C, the first external electrode 21 covers the entire first end surface 11 of the laminated body 10, and extends from the first end surface 11 to cover a part of the first main surface 13, a part of the second main surface 14, a part of the first side surface 15, and a part of the second side surface 16. The second external electrode 22 covers the entire second end surface 12 of the laminated body 10, and extends from the second end surface 12 to cover a part of the first main surface 13, a part of the second main surface 14, a part of the first side surface 15, and a part of the second side surface 16.

Since the first external electrode 21 and the second external electrode 22 are disposed as described above, when the laminated coil component 1 is mounted on a substrate, any one of the first main surface 13, the second main surface 14, the first side surface 15, and the second side surface 16 of the laminated body 10 can be a mounting surface, but in the present embodiment, the first main surface 13 is set as the mounting surface.

However, the first external electrode 21 may extend over the mounting surface of the laminated body 10 from at least a part of the first end surface 11 of the laminated body 10.

Similarly, the second external electrode 22 may extend over the mounting surface of the laminated body 10 from at least a part of the second end surface 12 of the laminated body 10.

The size of the laminated coil component of the present disclosure is not particularly limited, but is preferably a 0402 size or a size similar thereto.

More specifically, the laminated body satisfies B_W≤200 μm, B_L≤400 μm, and 200 μm≤B_T where the dimensions of the laminated body in the width direction (z direction), the height direction (y direction), and the length direction (x direction) are B_W (length indicated by double-headed arrow B_W in FIG. 2C), B_T (length indicated by double-headed arrow B_T in FIG. 2B), and B_L (length indicated by double-headed arrow B_L in FIG. 2A), respectively. In the present disclosure, when simply referring to the laminated body 10, the first external electrode 21 and the second external electrode 22 are not included in the laminated body 10. Therefore, B_W, B_L, and B_T each refers to a dimension that does not include the first external electrode 21 and the second external electrode 22.

The laminated body preferably satisfies 160 μm≤B_W≤200 μm, and more preferably satisfies 170 μm≤B_W≤190 μm. The laminated body preferably satisfies 340 μm≤B_L≤380 μm, and more preferably satisfies 350 μm≤B_L≤370 μm. The laminated body preferably satisfies 210 μm≤B_T≤300 μm, and more preferably satisfies 260 μm≤B_T≤300 μm.

In addition, when the dimensions of the laminated coil component in the width direction (z direction), the height direction (y direction), and the length direction (x direction) are W (length indicated by double-headed arrow W in FIG. 2C), T (length indicated by double-headed arrow T in FIG. 2B), and L (length indicated by double-headed arrow L in FIG. 2A), respectively, the laminated coil component preferably satisfies 180 μm≤W≤220 μm, and more preferably satisfies 190 μm≤W≤210 μm. The laminated coil component preferably satisfies 380 μm≤L≤420 μm, and more preferably satisfies 390 μm≤L≤410 μm. The laminated coil component preferably satisfies 230 μm≤T≤320 μm, and more preferably satisfies 270 μm≤T≤310 μm.

As described above, the laminated coil component of the present disclosure corresponds to downsizing in the sense of reducing the mounting area.

The coil incorporated in the laminated body constituting the laminated coil component of the present disclosure will be described.

The coil is formed by electrically connecting a plurality of coil conductors each laminated together with the insulating layer in the length direction to each other.

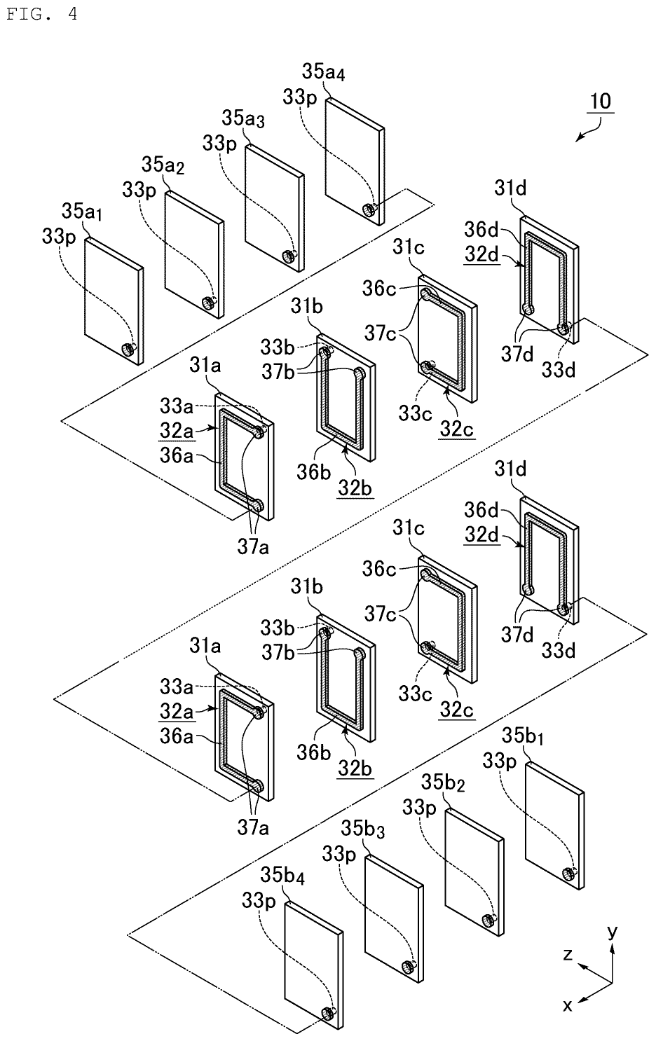

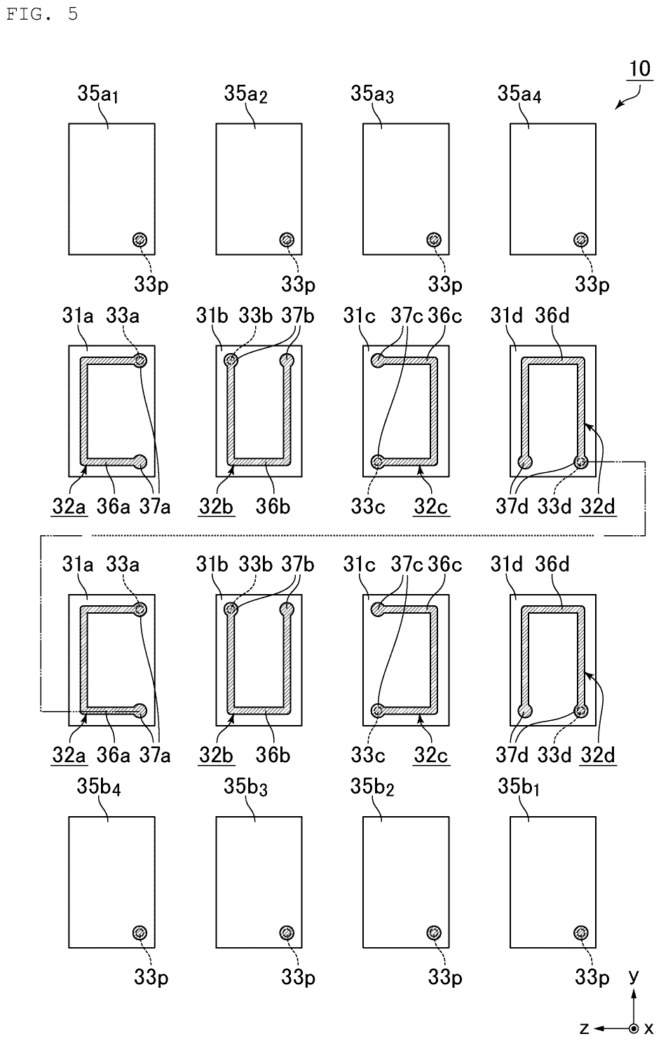

FIG. 3 is a sectional view schematically illustrating an example of the laminated coil component of the first embodiment, FIG. 4 is an exploded perspective view schematically illustrating a state of the insulating layer constituting the laminated coil component illustrated in FIG. 3, and FIG. 5 is an exploded plan view schematically illustrating a state of the insulating layers constituting the laminated coil component illustrated in FIG. 3.

FIG. 3 schematically illustrates lamination directions of the insulating layers, the coil conductors, coupling conductors, and the laminated body, and does not strictly illustrate an actual shape, connection, and the like. For example, the coil conductors are connected to each other with a via conductor interposed therebetween.

As illustrated in FIG. 3, the laminated coil component 1 includes the laminated body 10 incorporating a coil 30 formed by electrically connecting a plurality of coil conductors 32 each laminated together with an insulating layer 31 to each other, and the first external electrode 21 and the second external electrode 22 each electrically connected to the coil 30. In the laminated body 10, a region where the coil conductors 32 are disposed and a region where a coupling conductor 41 or a coupling conductor 42 is disposed are present. The lamination direction of the laminated body 10 and an axis direction of the coil (in FIG. 3, indicating a coil axis A) are parallel to the first main surface 13.

In the present specification, a direction in which the plurality of insulating layers constituting the laminated body are laminated is referred to as the lamination direction.

As illustrated in FIG. 3, actually, a boundary is not visually recognized between the adjacent insulating layers 31.

As illustrated in FIGS. 4 and 5, the laminated body 10 includes an insulating layer 31a, an insulating layer 31b, an insulating layer 31c, and an insulating layer 31d as the insulating layer 31 in FIG. 3. The laminated body 10 includes an insulating layer 35a₁, an insulating layer 35a₂, an insulating layer 35a₃, and an insulating layer 35a₄ as an insulating layer 35a in FIG. 3. The laminated body 10 includes an insulating layer 35b₁, an insulating layer 35b₂, an insulating layer 35b₃, and an insulating layer 35b₄ as an insulating layer 35b in FIG. 3.

Examples of a constituent material of each insulating layer include a magnetic material such as a ferrite material, and among them, a mixed material of the ferrite material and a non-magnetic material having a dielectric constant lower than that of the ferrite material is preferable. Thereby, high frequency characteristics of the laminated coil component of the present disclosure can be improved.

Examples of the ferrite material include Ni—Zn—Cu-based ferrite materials.

Examples of the non-magnetic material having a dielectric constant lower than that of the ferrite material include glass ceramic and willemite.

The coil 30 includes a coil conductor 32a, a coil conductor 32b, a coil conductor 32c, and a coil conductor 32d as the coil conductor 32 in FIG. 3.

The coil conductor 32a, the coil conductor 32b, the coil conductor 32c, and the coil conductor 32d are disposed on main surfaces of the insulating layer 31a, the insulating layer 31b, the insulating layer 31c, and the insulating layer 31d, respectively.

The lengths of each of the coil conductor 32a, the coil conductor 32b, the coil conductor 32c, and the coil conductor 32d is the length of ¾ turns of the coil 30. That is, the lamination number of the coil conductors for constituting three turns of the coil 30 is four. In the laminated body 10, the coil conductor 32a, the coil conductor 32b, the coil conductor 32c, and the coil conductor 32d are repeatedly laminated as one unit (for three turns).

The coil conductor 32a includes a line portion 36a and a land portion 37a disposed at an end portion of the line portion 36a. The coil conductor 32b includes a line portion 36b and a land portion 37b disposed at an end portion of the line portion 36b. The coil conductor 32c includes a line portion 36c and a land portion 37c disposed at an end portion of the line portion 36c. The coil conductor 32d includes a line portion 36d and a land portion 37d disposed at an end portion of the line portion 36d. Hereinafter, the line portion 36a, the line portion 36b, the line portion 36c, and the line portion 36d are also collectively referred to as a line portion 36.

A via conductor 33a, a via conductor 33b, a via conductor 33c, and a via conductor 33d are disposed in the insulating layer 31a, the insulating layer 31b, the insulating layer 31c, and the insulating layer 31d, respectively, so as to penetrate thereof in the lamination direction.

The insulating layer 31a with the coil conductor 32a and the via conductor 33a, the insulating layer 31b with the coil conductor 32b and the via conductor 33b, the insulating layer 31c with the coil conductor 32c and the via conductor 33c, and the insulating layer 31d with the coil conductor 32d and the via conductor 33d are repeatedly laminated as one unit. As a result, the land portion 37a of the coil conductor 32a, the land portion 37b of the coil conductor 32b, the land portion 37c of the coil conductor 32c, and the land portion 37d of the coil conductor 32d are connected to each other with the via conductor 33a, the via conductor 33b, the via conductor 33c, and the via conductor 33d interposed therebetween. That is, the land portions of the coil conductors adjacent to each other in the lamination direction are connected to each other with the via conductor interposed therebetween.

As described above, the coil 30 having a solenoid shape incorporated in the laminated body 10 is configured.

Examples of the constituent material of each coil conductor and each via conductor include Ag, Au, Cu, Pd, Ni, Al, and an alloy containing at least one of these metals.

The shape of the plurality (or all) of the coil conductors 32 when transparently viewed in an overlapping manner from the lamination direction is not particularly limited, and may be a square, but is preferably a rectangle. At this time, the shape of each coil conductor 32 may be a square with some of sides open, but is more preferably a rectangle with some of sides open. As a result, it is possible to secure a side gap while effectively expanding an inner diameter area of the coil 30.

As described above, in the present specification, the “rectangle” means a quadrangle that is not a square among quadrangles in which all four corners are equal. In addition, a “rectangular shape” includes a square and means a quadrangle having four equal corners.

In plan view from the lamination direction, the diameters of the land portion 37a, the land portion 37b, the land portion 37c, and the land portion 37d are preferably larger than the line widths of the line portion 36a, the line portion 36b, the line portion 36c, and the line portion 36d, respectively, as illustrated in FIG. 5.

In plan view from the lamination direction, the land portion 37a, the land portion 37b, the land portion 37c, and the land portion 37d may each have a circular shape as illustrated in FIG. 5 or a polygonal shape.

A via conductor 33p is disposed in each of the insulating layer 35a₁, the insulating layer 35a₂, the insulating layer 35a₃, and the insulating layer 35a₄ so as to penetrate thereof in the lamination direction. A land portion connected to the via conductor 33p may be disposed on each of the main surfaces of the insulating layer 35a₁, the insulating layer 35a₂, the insulating layer 35a₃, and the insulating layer 35a₄.

The insulating layer 35a₁ with the via conductor 33p, the insulating layer 35a₂ with the via conductor 33p, the insulating layer 35a₃ with the via conductor 33p, and the insulating layer 35a₄ with the via conductor 33p are laminated so as to overlap the insulating layer 31a with the coil conductor 32a and the via conductor 33a. As a result, the via conductors 33p are connected to each other to form the first coupling conductor 41, and the first coupling conductor 41 is exposed to the first end surface 11. As a result, the first external electrode 21 and the coil 30 are connected to each other with the first coupling conductor 41 interposed therebetween.

As described above, the first coupling conductor 41 preferably linearly connects the first external electrode 21 and the coil 30 to each other. That the first coupling conductor 41 linearly connects the first external electrode 21 and the coil 30 to each other means that the via conductors 33p constituting the first coupling conductor 41 overlap each other in plan view from the lamination direction, and the via conductors 33p need not be strictly linearly aligned.

The via conductor 33p is disposed in each of the insulating layer 35b₁, the insulating layer 35b₂, the insulating layer 35b₃, and the insulating layer 35b₄ so as to penetrate thereof in the lamination direction. A land portion connected to the via conductor 33p may be disposed on the main surfaces of the insulating layer 35b₁, the insulating layer 35b₂, the insulating layer 35b₃, and the insulating layer 35b₄.

The insulating layer 35b₁ with the via conductor 33p, the insulating layer 35b₂ with the via conductor 33p, the insulating layer 35b₃ with the via conductor 33p, and the insulating layer 35b₄ with the via conductor 33p are laminated so as to overlap the insulating layer 31d with the coil conductor 32d and the via conductor 33d. As a result, the via conductors 33p are connected to each other to form the second coupling conductor 42, and the second coupling conductor 42 is exposed to the second end surface 12. As a result, the second external electrode 22 and the coil 30 (coil conductor 32d) are connected to each other with the second coupling conductor 42 interposed therebetween.

As described above, the second coupling conductor 42 preferably linearly connects the second external electrode 22 and the coil 30 to each other. That the second coupling conductor 42 linearly connects the second external electrode 22 and the coil 30 to each other means that the via conductors 33p constituting the second coupling conductor 42 overlap each other in plan view from the lamination direction, and the via conductors 33p need not be strictly linearly aligned.

In FIGS. 4 and 5, the case in which the lamination number of the coil conductors for constituting the three turns of the coil 30 is four, that is, the case in which the repetitive shape is a ¾ turn shape is exemplified, but the number of lamination of the coil conductors for constituting one turn of the coil is not particularly limited. For example, the lamination number of the coil conductors for forming one turn of the coil may be two, that is, the repetitive shape may be a ½ turn shape.

The number of turns of the coil 30 is also not particularly limited, but is preferably 10 turns or more, more preferably 15 turns or more, and still more preferably 20 turns or more from the viewpoint of improving low frequency characteristics. The number of turns of the coil 30 is preferably 35 turns or less, more preferably 30 turns or less, and still more preferably 25 turns or less.

It is preferable that the coil conductors constituting the coil overlap each other in plan view from the lamination direction. In addition, the shape of the coil (coil conductor) is preferably rectangular shape (more preferably a rectangle) in plan view from the lamination direction. When the coil includes the land portion, the shape excluding the land portion (that is, the shape of the line portion) is set as the shape of the coil (coil conductor).

FIGS. 6 to 8 are plan views each schematically illustrating another example of the repetitive shape of the coil conductor constituting the laminated coil component illustrated in FIG. 3. Note that FIGS. 6 to 8 correspond to diagrams when the laminated body is viewed (viewed through) in the coil axis direction.

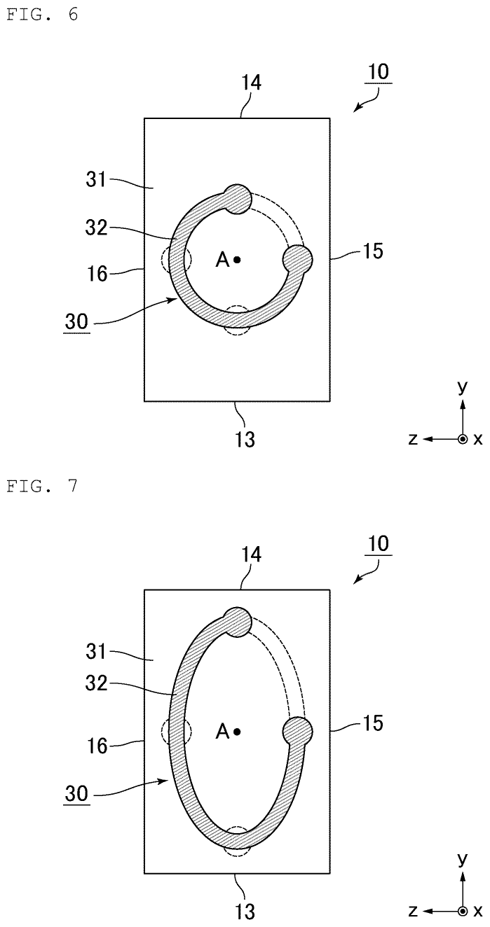

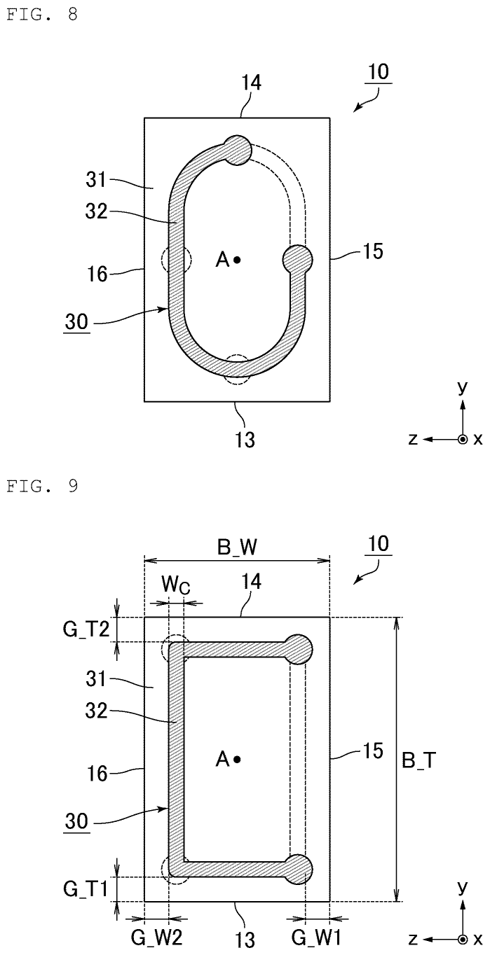

The coil conductor illustrated in FIG. 4 has a shape in which the repetitive pattern is a rectangle, but the coil conductor may have a shape in which the repetitive pattern is a circle (see FIG. 6), an ellipse (see FIG. 7), or a track shape (see FIG. 8). The track shape represents a shape in which a pair of sides of a rectangle facing each other are expanded in a semicircular shape. In a case in which the shape of the coil conductor is a shape having a longitudinal direction and a lateral direction such as the rectangle, the ellipse, or the track shape, each coil conductor is preferably disposed such that the longitudinal direction is parallel to the height direction. The repetitive shape of the coil conductor may be the ½ turn shape instead of the ¾ turn shape.

FIG. 9 is a plan view schematically illustrating the repetitive shape of the coil conductor constituting the laminated coil component illustrated in FIG. 3. Note that FIG. 9 correspond to a diagram when the laminated body is viewed (viewed through) in the coil axis direction. The repetitive shape of the coil 30 (coil conductor 32) illustrated in FIG. 9 is a rectangular shape, particularly a rectangle.

The inner diameter area of the coil 30 is larger than a predetermined area, specifically, 7500 μm² or more. As a result, since the impedance on the low frequency side increases, the low frequency characteristics are improved, and the transmission coefficient S21 in the low frequency band can be improved. The transmission coefficient S21 is obtained from a ratio of the power of the transmission signal to the power of the input signal. The transmission coefficient S21 for each frequency is obtained using, for example, a network analyzer. The transmission coefficient S21 is basically a dimensionless amount, but is usually expressed in dB by taking a common logarithm.

From the viewpoint of improving the low frequency characteristics, the inner diameter area of the coil 30 is preferably 10000 μm² or more, more preferably 13000 μm² or more, and still more preferably 15000 μm² or more. The upper limit of the inner diameter area of the coil 30 is not particularly limited, but is preferably 25000 μm² or less, more preferably 20,000 μm² or less, and still more preferably 18000 μm² or less.

Here, the “inner diameter area of the coil” means an area of a region surrounded by the coil when the laminated body is viewed in the coil axis direction. For example, when the shape of each coil conductor is a rectangle, as illustrated in FIG. 9, the inner diameter area of the coil can be calculated from the following equation, where the dimension of the laminated body 10 in the width direction is B_W, the dimension of the laminated body 10 in the height direction is B_T, the width of the line portion 26 constituting the coil conductor 32 is W_{C}, a distance between the coil 30 and the first side surface 15 in the width direction is a side gap G_W1, a distance between the coil 30 and the second side surface 16 in the width direction is a side gap G_W2, a distance between the coil 30 and the first main surface 13 in the height direction is a side gap G_T1, and a distance between the coil 30 and the second main surface 14 in the height direction is a side gap G_T2. Inner diameter area of coil=(B_W−G_W1−G_W2−W_{C}×2)×(B_T−G_T1−G_T2−W_{C}×2)

For example, when the shape of each coil conductor is circular, the inner diameter area of the coil can be calculated from the following equation.

$$Inner diameter area of coil = {( inner diameter of coil \div 2 )}^{2} \times π$$

For example, when the shape of each coil conductor is elliptical, the inner diameter area of the coil can be calculated from the following equation. Inner diameter area of coil=inner diameter of coil in long axis direction×inner diameter of coil in short axis direction×π

In addition, also in a case in which the shape of each coil conductor is a track shape, the inner diameter area of the coil can be similarly calculated by a mathematical method.

In the present specification, the “inner diameter area of the coil” is a value obtained by calculating the inner diameter area of the coil at each of three intermediate points when the laminated body is divided into four equal parts in the length direction or at each point where the coil conductor closest to a respective one of the three intermediate points is present, and taking the arithmetic average thereof.

Similarly, other dimensions such as the width of the line portion, the side gap, the inner diameter of the coil, and the thickness of the coil conductor are also values obtained by calculating the dimensions at three intermediate points when the laminated body is divided into four equal parts in the length direction or at each point where the coil conductor closest to a respective one of the three intermediate points is present, and taking the arithmetic average thereof.

In the laminated coil component of the present disclosure, the transmission coefficient S21 at 1 GHz is preferably −1.0 dB or more, the transmission coefficient S21 at 1 GHz is more preferably −0.8 dB or more, the transmission coefficient S21 at 1 GHz is still more preferably −0.6 dB or more, and the transmission coefficient S21 at 1 GHz is particularly preferably −0.4 dB or more.

The laminated body 10 preferably satisfies G_W1≥10 μm, G_W2≥10 μm, G_T1≥10 μm, and G_T2≥10 μm where, as illustrated in FIG. 9, the distance between the coil 30 and the first side surface 15 in the width direction is the side gap G_W1, the distance between the coil 30 and the second side surface 16 in the width direction is the side gap G_W2, the distance between the coil 30 and the first main surface 13 in the height direction is the side gap G_T1, and the distance between the coil 30 and the second main surface 14 in the height direction is the side gap G_T2 when the laminated body 10 is viewed in the direction of the coil axis A. When at least one of these side gaps is less than 10 μm, there is a possibility that manufacturing inconvenience, for example, exposure of the coil conductor 32 from the laminated body 10 occurs. Each of G_W1, G_W2, G_T1, and G_T2 is more preferably 15 μm or more and 30 μm or less (i.e., from 15 μm to 30 μm), and still more preferably 20 μm or more and 25 μm or less (i.e., from 20 μm to 25 μm).

As illustrated in FIG. 9, the width W_{C} of the line portion constituting the coil conductor 32 is not particularly limited, but is preferably 15 μm or more and 30 μm or less (i.e., from 15 μm to 30 μm), and more preferably 20 μm or more and 25 μm or less (i.e., from 20 μm to 25 μm).

In the laminated coil component of the present disclosure, the lamination number of the coil conductors is not particularly limited, but is preferably 10 or more and 50 or less (i.e., from 10 to 50), more preferably 20 or more and 40 or less (i.e., from 20 to 40), and still more preferably 25 or more and 35 or less (i.e., from 25 to 35).

### Second Embodiment

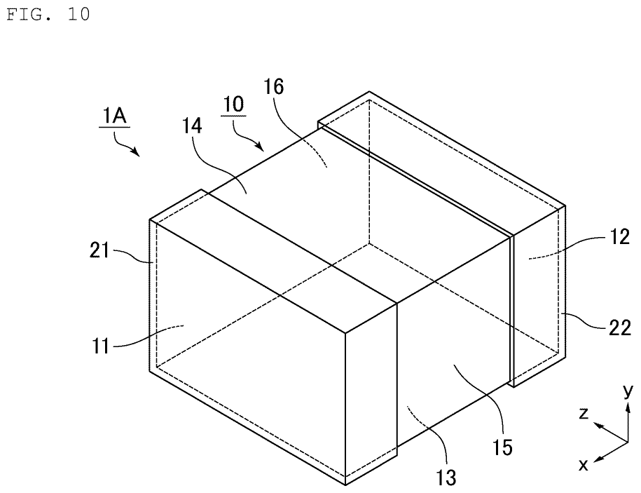

FIG. 10 is a schematic perspective view illustrating an example of a laminated coil component according to a second embodiment.

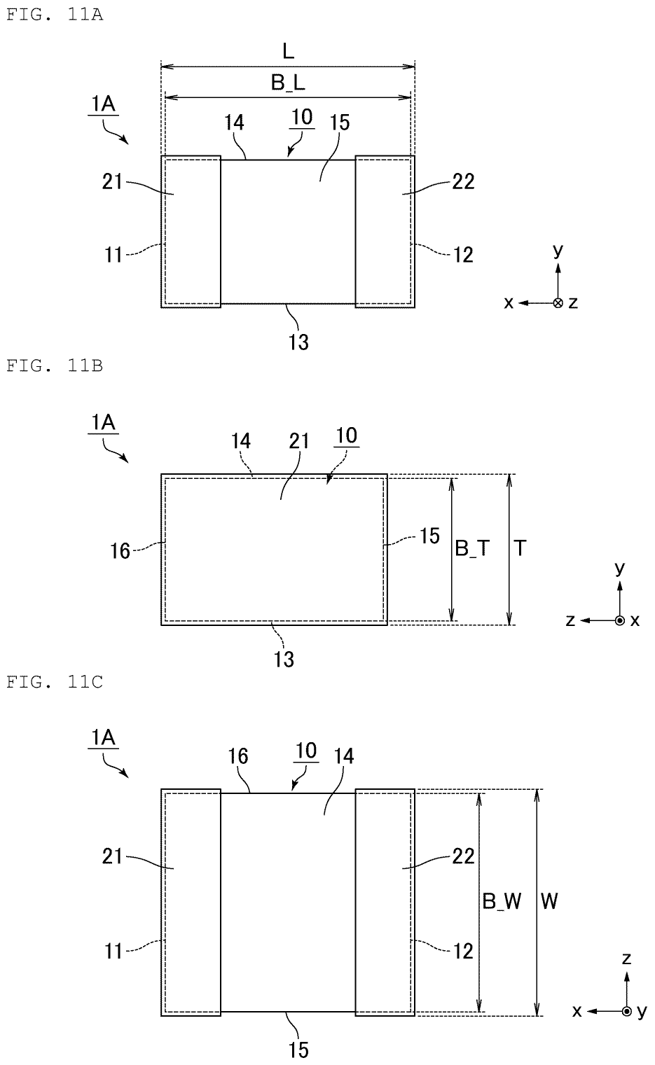

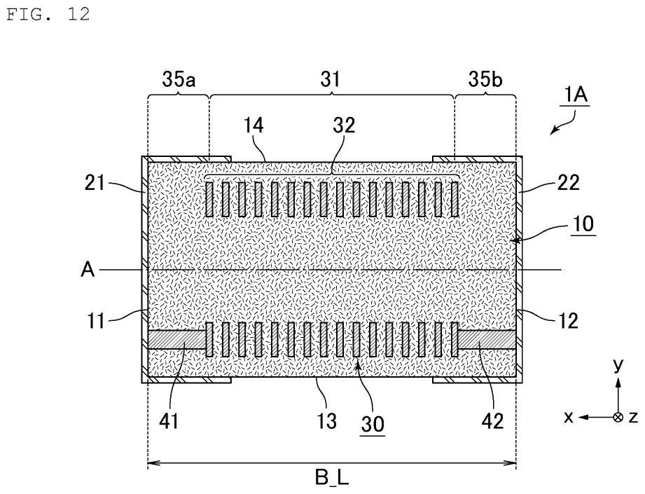

FIG. 11A is a side view of the laminated coil component illustrated in FIG. 10, FIG. 11B is a front view of the laminated coil component illustrated in FIG. 10, and FIG. 11C is a bottom view of the laminated coil component illustrated in FIG. 10.

A laminated coil component 1A illustrated in FIGS. 10, 11A, 11B, and 11C corresponds to downsizing in the sense of a low profile that clears height restriction.

More specifically, the laminated body satisfies B_T≤200 μm, B_L≤400 μm, and 200 μm≤B_W where the dimensions of the laminated body in the width direction (z direction), the height direction (y direction), and the length direction (x direction) are B_W (length indicated by double-headed arrow B_W in FIG. 11C), B_T (length indicated by double-headed arrow B_T in FIG. 11B), and B_L (length indicated by double-headed arrow B_L in FIG. 11A), respectively.

The laminated body preferably satisfies 210 μm≤B_W≤300 μm, and more preferably satisfies 260 μm≤B_W≤300 μm. The laminated body preferably satisfies 340 μm≤B_L≤380 μm, and more preferably satisfies 350 μm≤B_L≤370 μm. The laminated body preferably satisfies 160 μm≤B_T≤200 μm, and more preferably satisfies 170 μm≤B_T≤190 μm.

In addition, when the dimensions of the laminated coil component in the width direction (z direction), the height direction (y direction), and the length direction (x direction) are W (length indicated by double-headed arrow W in FIG. 11C), T (length indicated by double-headed arrow T in FIG. 11B), and L (length indicated by double-headed arrow L in FIG. 11A), respectively, the laminated coil component preferably satisfies 230 μm≤W≤320 μm, and more preferably satisfies 270 μm≤W≤310 μm. The laminated coil component preferably satisfies 380 μm≤L≤420 μm, and more preferably satisfies 390 μm≤L≤410 μm. The laminated coil component preferably satisfies 180 μm≤T≤220 μm, and more preferably satisfies 190 μm≤T≤210 μm.

Also in the present embodiment, as in the case of the first embodiment, any one of the first main surface 13, the second main surface 14, the first side surface 15, and the second side surface 16 of the laminated body 10 may be the mounting surface, but the first main surface 13 is set as the mounting surface.

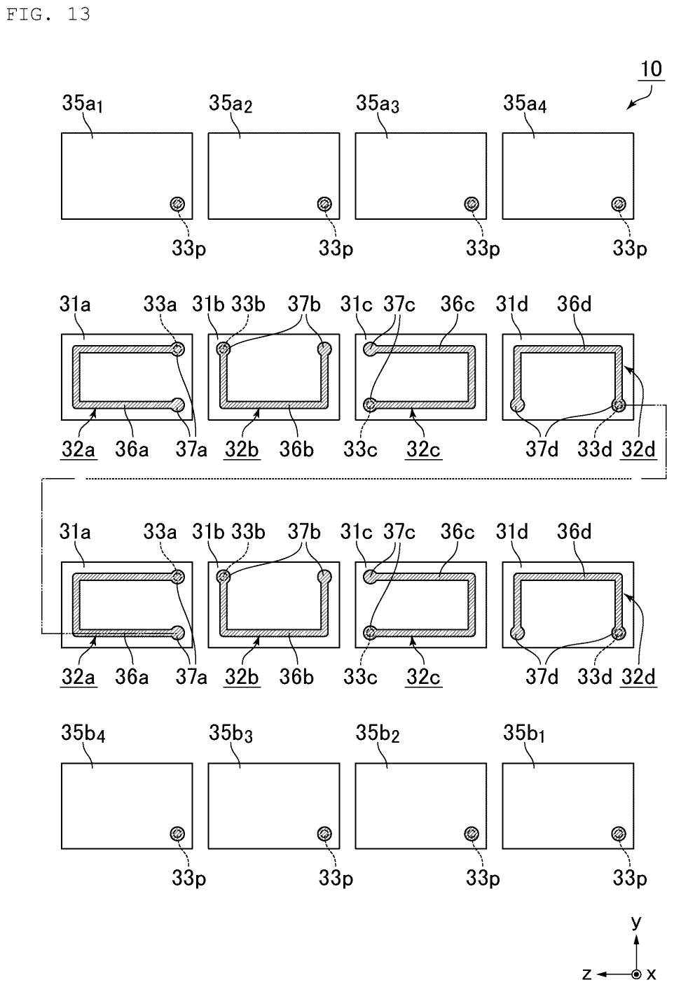

FIG. 12 is a sectional view schematically illustrating an example of a laminated coil component of the second embodiment, and FIG. 13 is a schematic exploded plan view schematically illustrating a state of insulating layers constituting the laminated coil component illustrated in FIG. 12.

FIG. 12 schematically illustrates lamination directions of the insulating layers, the coil conductors, coupling conductors, and the laminated body, and does not strictly illustrate an actual shape, connection, and the like. For example, the coil conductors are connected to each other with a via conductor interposed therebetween.

As illustrated in FIGS. 12 and 13, similarly to the laminated coil component 1 of the first embodiment, a laminated coil component 1A includes the laminated body 10 incorporating the coil 30 formed by electrically connecting a plurality of the coil conductors 32 each laminated together with the insulating layer 31 to each other, and the first external electrode 21 and the second external electrode 22 each electrically connected to the coil 30.

Also in the laminated coil component 1A, similarly to the laminated coil component 1 of the first embodiment, since the inner diameter area of the coil 30 is larger than the predetermined area, the transmission coefficient S21 in the low frequency band can be improved. That is, the inner diameter area of the coil 30 is 7500 μm² or more, preferably 10,000 μm² or more, more preferably 13000 μm² or more, and still more preferably 15000 μm² or more. The inner diameter area of the coil 30 is preferably 25000 μm² or less, more preferably 20000 μm² or less, and still more preferably 18000 μm² or less.

Also in the present embodiment, the shape of each coil conductor 32 in plan view from the lamination direction is not particularly limited, but In a case in which the shape of the coil conductor 32 is a shape having a longitudinal direction and a lateral direction such as the rectangle, the ellipse, or the track shape, each coil conductor 32 is preferably disposed such that the longitudinal direction is parallel to the width direction.

### [Method for Manufacturing Laminated Coil Component]

An example of a method for manufacturing the laminated coil component of the present disclosure will be described.

First, a ceramic green sheet to be an insulating layer later is prepared. For example, first, an organic binder such as a polyvinyl butyral resin, an organic solvent such as ethanol or toluene, a dispersant, and the like are added to and kneaded with the ferrite material to form a slurry. Thereafter, a ceramic green sheet having a thickness of from about 10 μm to about 25 μm is prepared by a method such as a doctor blade method.

Examples of the ferrite material include those prepared by the following method. First, oxide raw materials of iron, nickel, zinc, and copper are mixed and pre-fired at 800° C. for 1 hour. Thereafter, the obtained pre-fired product is pulverized by a ball mill and dried to prepare a Ni—Zn—Cu-based ferrite material (oxide mixed powder) having an average particle size of about 2 μm.

When a ceramic green sheet by using a ferrite material is prepared, in order to obtain high inductance, a composition of the ferrite material is preferably Fe₂O₃: 40 mol % or more and 49.5 mol % or less (i.e., from 40 mol % to 49.5 mol %), ZnO: 5 mol % or more and 35 mol % or less (i.e., from 5 mol % to 35 mol %), CuO: 4 mol % or more and 12 mol % or less (i.e., from 4 mol % to 12 mol %), and the remnant: NiO and a minor additive (including inevitable impurities).

As the material of the ceramic green sheet, for example, a non-magnetic material such as a glass ceramic material, willemite, or the like, a magnetic material, a mixed material of the magnetic material and the non-magnetic material, or the like may be used in addition to the magnetic material such as the above-described ferrite material.

Next, a conductor pattern to be the coil conductor and the via conductor later is formed on the ceramic green sheet. For example, first, the ceramic green sheet is subjected to laser processing to form a via hole. Then, the via hole is filled with a conductive paste such as a silver paste to form the conductor pattern for the via conductor. Further, the conductor pattern for the coil conductor is printed on the main surface of the ceramic green sheet by a method such as screen printing using the conductive paste such as the silver paste. As the conductor pattern for the coil conductor, for example, the conductor pattern corresponding to the coil conductor as illustrated in FIGS. 4 and 5 is printed. At this time, the conductor pattern for the coil conductor has such a shape that the inner diameter area of the coil to be obtained is 7500 μm² or more.

Thereafter, drying is performed to obtain a coil sheet having a configuration in which the conductor pattern for the coil conductor and the conductor pattern for the via conductor are formed on the ceramic green sheet. In the coil sheet, the conductor pattern for the coil conductor and the conductor pattern for the via conductor are connected to each other.

In addition, a via sheet having a configuration in which the conductor pattern for the via conductor is formed on a ceramic green sheet is prepared separately from the coil sheet. The conductor pattern for the via conductor of the via sheet is a conductor pattern to be a via conductor constituting a coupling conductor later.

Next, the coil sheets are laminated in a predetermined order such that a coil having a coil axis parallel to the mounting surface is formed inside the laminated body after singulation and firing. Further, the via sheets are laminated above and below the laminated body of the coil sheets.

Next, the laminated body of the coil sheets and the via sheets is heat pressure-bonded to obtain a pressure-bonded body, and then the pressure-bonded body is cut so as to have a predetermined chip size to obtain singulated chips. The singulated chip may be subjected to barrel polishing, for example, to round corners and ridges.

Next, the singulated chip is subjected to a debinding treatment and firing at a predetermined temperature and time, thereby forming a laminated body (fired body) incorporating the coil therein. At this time, the conductor pattern for the coil conductor and the conductor pattern for the via conductor become the coil conductor and the via conductor, respectively, after firing. The coil is formed by connecting the coil conductors to each other with the via conductor interposed therebetween. In addition, the lamination direction of the laminated body and the coil axis direction of the coil are parallel to the mounting surface.

Next, by vertically immersing and baking the laminated body in a layer obtained by stretching a conductive paste such as a silver paste to a predetermined thickness, base electrode layers of external electrodes are formed on five surfaces (an end surface, both main surfaces, and both end surfaces) of the laminated body. In addition, by obliquely immersing and baking the laminated body in the layer obtained by stretching the conductive paste such as the silver paste to a predetermined thickness, base electrode layers of external electrodes can be formed on four surfaces (a main surface, an end surface, and both side surfaces) of the laminated body.

Next, a nickel film and a tin film each having a predetermined thickness are sequentially formed on the base electrode layer by plating. As a result, the external electrode is formed.

As described above, the laminated coil component of the present disclosure is manufactured.

### EXAMPLES

Hereinafter, an example more specifically disclosing the laminated coil component of the present disclosure will be described. The present disclosure is not limited only to these examples.

### Preparation of Sample

### (Sample 1)

(1) A ferrite material (pre-fired powder) having a predetermined composition and a glass ceramic material having a predetermined composition were prepared.
(2) An organic binder (polyvinyl butyral-based resin) and an organic solvent (ethanol and toluene) were put in the above materials together with PSZ balls in a pot mill, and were sufficiently mixed and pulverized in a wet manner to prepare a magnetic slurry containing a non-magnetic material.
(3) The magnetic slurry was molded into a sheet by a doctor blade method, and the sheet was punched to be a rectangle to prepare a plurality of ceramic green sheets.
(4) A conductive paste for an inner conductor containing Ag powder and an organic vehicle was prepared.
(5) Preparation of a Via Sheet

Via holes were formed by irradiating a predetermined portion of the ceramic green sheet with a laser. The via hole was filled with the conductive paste to form the via conductor, and the conductive paste was screen-printed in a circular shape around the via conductor to form a land portion.
(6) Preparation of a Coil Sheet

A via hole was formed at a predetermined position of the ceramic green sheet and filled with a conductive paste to form a via conductor, and then a coil conductor including a land portion and a line portion was printed to obtain a coil sheet.
(7) These sheets were laminated in the order illustrated in FIGS. 4 and 5 so that the lamination number of the coil conductors was 28, and then heated and pressurized, and cut with a dicer to be singulated, thereby preparing a laminated molded body.
(8) The laminated molded body was placed in a firing furnace, subjected to a binder removal treatment at a temperature of 500° C. in an air atmosphere, and then fired at a temperature of 900°° C. to prepare a laminated body (fired). The dimensions of the thirty obtained laminated bodies were measured using a micrometer to obtain average values of B_L=360 μm, B_W=180 μm, and B_T=280 μm.
(9) A conductive paste for the external electrode containing Ag powder and glass frit was poured into a coating film forming tank to form a coating film having a predetermined thickness. A portion of the laminated body where the external electrode was to be formed was immersed in the coating film.
(10) After immersion, baking was performed at a temperature of about 800° C. to form the base electrode of the external electrode.
(11) A Ni film and a Sn film were sequentially formed on the base electrode by electrolytic plating to form the external electrode.

As described above, the laminated coil component (Sample 1) including the external electrode having the shape illustrated in FIGS. 1, 2A, 2B, and 2C and having the internal structure of the laminated body as illustrated in FIGS. 3, 4, and 5 was prepared. The dimensions of the thirty obtained laminated coil components were measured using a micrometer to obtain average values of L=400 μm, W=200 μm, and T=300 μm.

In Sample 1, the number of turns of the coil was set to 21, the lamination number of the coil conductors was set to 28, the width W_{C} of the line portion constituting the coil conductor was set to 26 μm, and the thickness of the coil conductor was set to 5 μm. The side gaps G_W1 and G_W2 were set to 22 μm, and the side gaps G_T1 and G_T2 were set to 92 μm. The distance between the coil conductors adjacent to each other in the lamination direction (hereinafter, the distance between the electrodes) was set to 5 μm, a coil length was set to 275 μm, an inner diameter R W in the width direction of the coil was set to 84 μm, an inner diameter R_T in the height direction of the coil was set to 94 μm, an inner diameter ratio of the coil was set to 1.12, and an outer layer thickness was set to 40 μm. The inner diameter area of the coil was set to 7896 μm².

The coil length is a length calculated from the following equation.

$$Coil length = lamination number of the coil conductors \times thickness of coil conductor + ( number of lamination of coil conductors - 1 ) \times distance between electrodes$$

The inner diameter ratio of the coil is a ratio calculated from the following equation.

$$Inner diameter ratio of coil = inner diameter R\_T in height direction of coil \div inner diameter R\_W in width direction of coil$$

The outer layer thickness is a length calculated from the following equation.

$$Outer layer thickness = ( dimension B\_L of element body in length direction - coil length ) \div 2$$

### (Samples 2 to 4)

Laminated coil components (Samples 2 to 4) were prepared by the same procedure as in Sample 1 except that the various parameters were changed as shown in Table 1.

TABLE 1

| Sample number | | 1 | 2 | 3 | 4 |
|---|---|---|---|---|---|
| Number of turns | | 21 | 21 | 21 | 21 |
| Element body size(μm) | B_L | 360 | 360 | 360 | 360 |
| | B_W | 180 | 180 | 180 | 180 |
| | B_T | 280 | 280 | 280 | 280 |
| Width of line portion(μm) | Wc | 26 | 26 | 26 | 26 |
| Thickness of coil conductor(μm) | | 5 | 5 | 5 | 5 |
| Side gap(μm) | G_T1, G_T2 | 92 | 52 | 32 | 22 |
| Side gap(μm) | G_W1, G_W2 | 22 | 22 | 22 | 22 |
| Distance between electrodes(μm) | | 5 | 5 | 5 | 5 |
| Coil length(μm) | | 275 | 275 | 275 | 275 |
| Inner diameter of coil(μm) | R_W | 84 | 84 | 84 | 84 |
| | R_T | 94 | 124 | 164 | 184 |
| Inner diameter area of coil(μm²) | R_W*R_T | 7896 | 10416 | 13776 | 15456 |
| Inner diameter ratio of coil | R_T/R_W | 1.12 | 1.47 | 1.95 | 2.19 |
| Outer layer thickness(μm) | R_T/R_W | 40 | 40 | 40 | 40 |

### (Samples 5 to 7)

Laminated coil components (Samples 5 to 7) were prepared by the same procedure as in Sample 1 except that the various parameters were changed as shown in Table 2.

TABLE 2

| Sample number | | 5* | 6 | 7 | 4 |
|---|---|---|---|---|---|
| Number of turns | | 21 | 21 | 21 | 21 |
| Element body size(μm) | B_L | 360 | 360 | 360 | 360 |
| | B_W | 180 | 180 | 180 | 180 |
| | B_T | 180 | 210 | 250 | 280 |
| Width of line portion(μm) | Wc | 26 | 26 | 26 | 26 |
| Thickness of coil conductor(μm) | | 5 | 5 | 5 | 5 |
| Side gap(μm) | G_T1, G_T2 | 22 | 22 | 22 | 22 |
| Side gap(μm) | G_W1, G_W2 | 22 | 22 | 22 | 22 |
| Distance between electrodes(μm) | | 5 | 5 | 5 | 5 |
| Coil length(μm) | | 275 | 275 | 275 | 275 |
| Inner diameter of coil(μm) | R_W | 84 | 84 | 84 | 84 |
| | R_T | 84 | 114 | 154 | 184 |
| Inner diameter area of coil(μm²) | R_W*R_T | 7056 | 9576 | 12936 | 15456 |
| Inner diameter ratio of coil | R_T/R_W | 1.00 | 1.36 | 1.83 | 2.19 |
| Outer layer thickness(μm) | R_T/R_W | 40 | 40 | 40 | 40 |

### (Measurement of Transmission Coefficient S21)

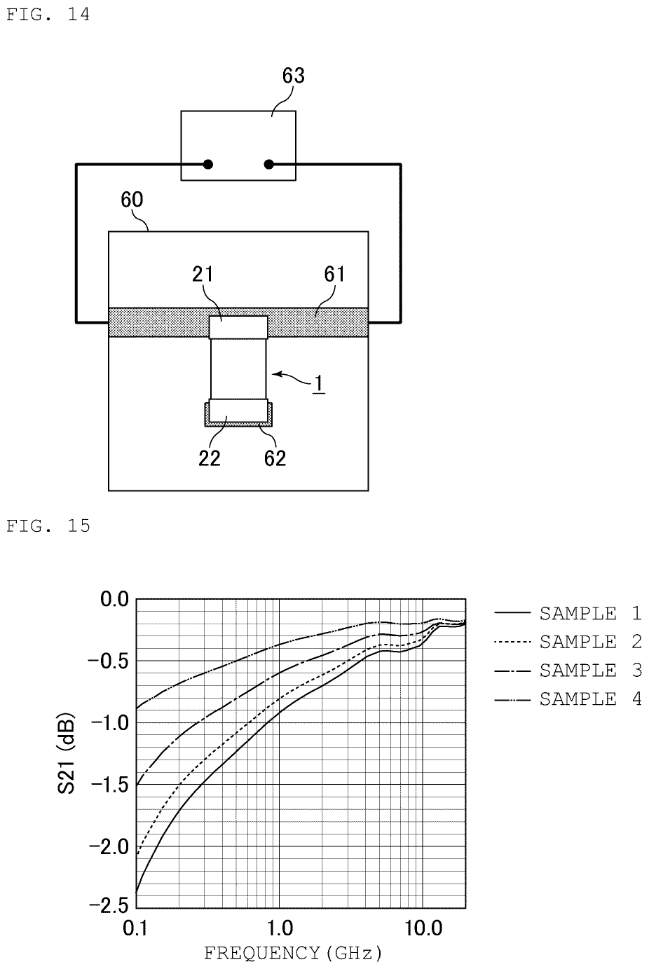

FIG. 14 is a view schematically illustrating a method of measuring the transmission coefficient S21.

As illustrated in FIG. 14, a sample (laminated coil component 1) was soldered to a measurement jig 60 provided with a signal path 61 and a ground conductor 62. The first external electrode 21 of the laminated coil component 1 is connected to the signal path 61, and the second external electrode 22 is connected to the ground conductor 62.

The power of the input signal and the transmission signal to the sample was obtained using a network analyzer 63, and the transmission coefficient S21 was measured by changing the frequency. One end and the other end of the signal path 61 are connected to the network analyzer 63.

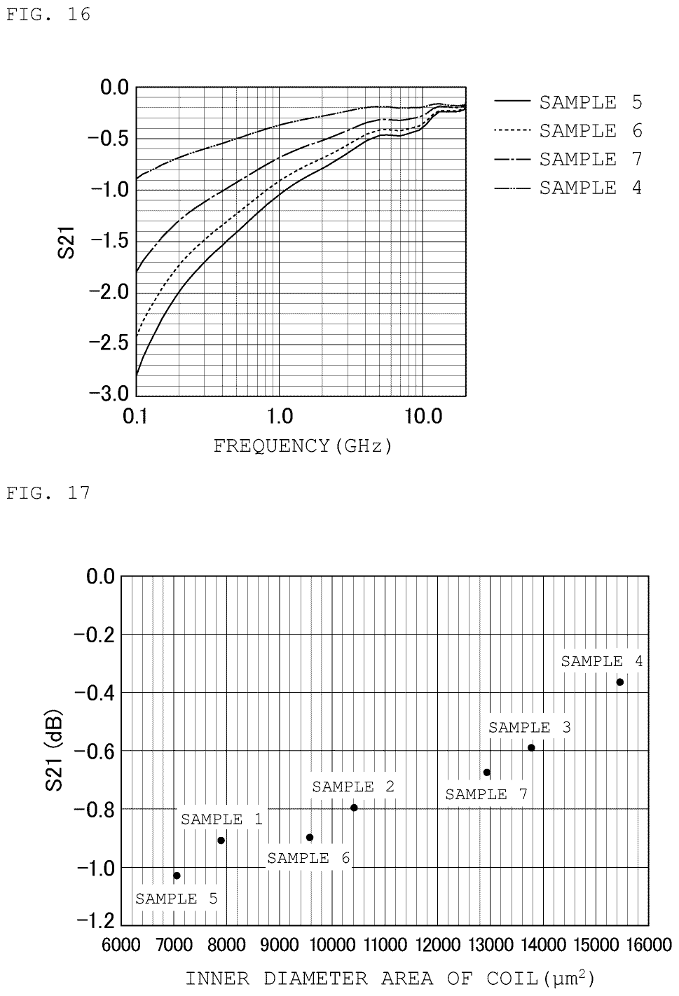

The measurement results are shown in FIGS. 15 and 16. FIG. 15 is a graph showing the transmission coefficients S21 of Samples 1 to 4. FIG. 16 is a graph showing the transmission coefficients S21 of Samples 4 to 7. Note that it is indicated that the closer the transmission coefficient S21 is to 0 dB, the smaller the loss is. FIG. 17 is a graph showing a relationship between the transmission coefficient S21 at 1 GHz and the inner diameter area of the coil in each sample.

From FIGS. 15 to 17, it can be said that there is a strong correlation between the transmission coefficient S21 at 1 GHz and the inner diameter area of the coil. In Samples 1 to 4, 6, and 7 each of which has a high profile while the mounting area was reduced to increase the inner diameter area of the coil, it was found that the transmission coefficient S21 at 1 GHZ was improved and the low frequency characteristics were excellent as compared with Sample 5 in which the dimension in the height direction was also small. Specifically, it has been found that the transmission coefficient S21 at 1 GHz can be −1.0 dB or more by setting the inner diameter area of the coil to 7500 μm² or more, the transmission coefficient S21 at 1 GHz can be −0.8 dB or more by setting the inner diameter area of the coil to 10000 μm² or more, the transmission coefficient S21 at 1 GHz can be −0.6 dB or more by setting the inner diameter area of the coil to 13000 μm² or more, and the transmission coefficient S21 at 1 GHz can be −0.4 dB or more by setting the inner diameter area of the coil to 15000 μm² or more.

The present specification discloses the following content.
<1> A laminated coil component including a laminated body formed by laminating a plurality of insulating layers in a length direction and incorporating a coil therein, and a first external electrode and a second external electrode each electrically connected to the coil. The coil is formed by electrically connecting a plurality of coil conductors each laminated together with the insulating layer in the length direction to each other. The laminated body includes a first end surface and a second end surface facing each other in the length direction, a first main surface and a second main surface facing each other in a height direction orthogonal to the length direction, and a first side surface and a second side surface facing each other in a width direction orthogonal to the length direction and the height direction. A lamination direction of the laminated body and a coil axis direction of the coil are parallel to the first main surface. The first main surface is a mounting surface. Also, the laminated body satisfies B_W≤200 μm, B_L≤400 μm, and 200 μm≤B_T, or B_T≤200 μm, B_L≤400 μm, and 200 μm≤B_W, where dimensions of the laminated body in the width direction, the height direction, and the length direction are defined as B_W, B_T, and B_L, respectively, and an inner diameter area of the coil is 7500 μm² or more.
<2> The laminated coil component according to <1>, wherein the inner diameter area of the coil is 10000 μm² or more.
<3> The laminated coil component according to <2>, wherein the inner diameter area of the coil is 13000 μm² or more.
<4> The laminated coil component according to <3>, wherein the inner diameter area of the coil is 15000 μm² or more.
<5> The laminated coil component according to any one of <1> to <4>, wherein the laminated body includes a mixed material of a ferrite material and a non-magnetic material having a dielectric constant lower than that of the ferrite material.
<6> The laminated coil component according to any one of <1> to <5>, wherein the laminated body satisfies G_W1≥10 μm, G_W2≥10 μm, G_T1≥10 μm, and G_T2≥10 μm, where a distance between the coil and the first side surface in the width direction is a side gap G_W1, a distance between the coil and the second side surface in the width direction is a side gap G_W2, a distance between the coil and the first main surface in the height direction is a side gap G_T1, and a distance between the coil and the second main surface in the height direction is a side gap G_T2.
<7> The laminated coil component according to any one of <1> to <6>, wherein a shape of the plurality of coil conductors when transparently viewed in an overlapping manner from the lamination direction is a rectangle.
<8> The laminated coil component according to any one of claims <1> to <7>, wherein the number of turns of the coil is 10 turns or more.

What is claimed is:

1. A laminated coil component comprising:
a laminated body including a plurality of insulating layers laminated in a length direction, and a coil therein; and
a first external electrode and a second external electrode each electrically connected to the coil, wherein
the coil includes a plurality of coil conductors that are electrically connected and each laminated together with the insulating layer in the length direction,
the laminated body includes a first end surface and a second end surface facing each other in the length direction, a first main surface and a second main surface facing each other in a height direction orthogonal to the length direction, and a first side surface and a second side surface facing each other in a width direction orthogonal to the length direction and the height direction,
a lamination direction of the laminated body and a coil axis direction of the coil are parallel to the first main surface,
the first main surface is a mounting surface,
where dimensions of the laminated body in the width direction, the height direction, and the length direction are defined as BW, BT, and BL, respectively,
the laminated body satisfies BW≤200 μm, BL≤400 μm, and 200 μm≤BT, or BT≤200 μm, BL≤400 μm, and 200 μm≤BW and
an inner diameter area of the coil is 7500 μm² or more.

2. The laminated coil component according to claim 1, wherein the inner diameter area of the coil is 10000 μm² or more.

3. The laminated coil component according to claim 2, wherein the inner diameter area of the coil is 13000 μm² or more.

4. The laminated coil component according to claim 3, wherein the inner diameter area of the coil is 15000 μm² or more.

5. The laminated coil component according to claim 1, wherein
the laminated body includes a mixed material of a ferrite material and a non-magnetic material having a dielectric constant lower than that of the ferrite material.

6. The laminated coil component according to claim 1, wherein
where a distance between the coil and the first side surface in the width direction is a side gap GW1,
a distance between the coil and the second side surface in the width direction is a side gap GW2,
a distance between the coil and the first main surface in the height direction is a side gap GT1, and
a distance between the coil and the second main surface in the height direction is a side gap GT2,
the laminated body satisfies GW1≥10 μm, GW2≥10 μm, GT1≥10 μm, and GT2≥10 μm.

7. The laminated coil component according to claim 1, wherein
a shape of the plurality of coil conductors when transparently viewed in an overlapping manner from the lamination direction is a rectangle.

8. The laminated coil component according to claim 1, wherein
a number of turns of the coil is 10 turns or more.

9. The laminated coil component according to claim 2, wherein
the laminated body includes a mixed material of a ferrite material and a non-magnetic material having a dielectric constant lower than that of the ferrite material.

10. The laminated coil component according to claim 3, wherein
the laminated body includes a mixed material of a ferrite material and a non-magnetic material having a dielectric constant lower than that of the ferrite material.

11. The laminated coil component according to claim 4, wherein
the laminated body includes a mixed material of a ferrite material and a non-magnetic material having a dielectric constant lower than that of the ferrite material.

12. The laminated coil component according to claim 2, wherein
where a distance between the coil and the first side surface in the width direction is a side gap GW1,
a distance between the coil and the second side surface in the width direction is a side gap GW2,
a distance between the coil and the first main surface in the height direction is a side gap GT1, and
a distance between the coil and the second main surface in the height direction is a side gap GT2,
the laminated body satisfies GW1≥10 μm, GW2≥10 μm, GT1≥10 μm, and GT2≥10 μm.

13. The laminated coil component according to claim 3, wherein
where a distance between the coil and the first side surface in the width direction is a side gap GW1,
a distance between the coil and the second side surface in the width direction is a side gap GW2,
a distance between the coil and the first main surface in the height direction is a side gap GT1, and
a distance between the coil and the second main surface in the height direction is a side gap GT2,
the laminated body satisfies GW1≥10 μm, GW2≥10 μm, GT1≥10 μm, and GT2≥10 μm.

14. The laminated coil component according to claim 4, wherein
where a distance between the coil and the first side surface in the width direction is a side gap GW1,
a distance between the coil and the second side surface in the width direction is a side gap GW2,
a distance between the coil and the first main surface in the height direction is a side gap GT1, and
a distance between the coil and the second main surface in the height direction is a side gap GT2,
the laminated body satisfies GW1≥10 μm, GW2≥10 μm, GT1≥10 μm, and GT2≥10 μm.

15. The laminated coil component according to claim 2, wherein
a shape of the plurality of coil conductors when transparently viewed in an overlapping manner from the lamination direction is a rectangle.

16. The laminated coil component according to claim 3, wherein
a shape of the plurality of coil conductors when transparently viewed in an overlapping manner from the lamination direction is a rectangle.

17. The laminated coil component according to claim 4, wherein
a shape of the plurality of coil conductors when transparently viewed in an overlapping manner from the lamination direction is a rectangle.

18. The laminated coil component according to claim 2, wherein
a number of turns of the coil is 10 turns or more.

19. The laminated coil component according to claim 3, wherein
a number of turns of the coil is 10 turns or more.

20. The laminated coil component according to claim 4, wherein
a number of turns of the coil is 10 turns or more.
